(19) United States
(12) Patent Application Publication
(10) Pub. No.: US 2026/0233496 A1
(43) Pub. Date: Aug. 13, 2026

(54) ACOUSTIC INSULATING PANEL USING RECYCLED MATERIAL

(71) Applicant: CSR Industries Inc., Toronto (CA)

(72) Inventor: Paul Charles DOWNEY, Toronto (CA)

(73) Assignee: CSR Industries Inc., Toronto (CA)

(21) Appl. No.: 19/542,145

(22) Filed: Feb. 17, 2026

Related U.S. Application Data
(63) Continuation of application No. 17/209,592, filed on Mar. 23, 2021, now abandoned.

(51) Int. Cl. B32B 21/04; A47G 27/02; B32B 3/06; B32B 5/02; B32B 7/12; B32B 21/14; B32B 27/12; B32B 27/30; B32B 37/12; B32B 37/16; B32B 38/00; E04F 15/04; E04F 15/10; E04F 15/20; G10K 11/168

(52) U.S. Cl. CPC B32B 21/045; A47G 27/02; B32B 3/06; B32B 5/02; B32B 7/12; B32B 21/14; B32B 27/12; B32B 27/30; B32B 37/1284; B32B 37/16; B32B 38/0004; E04F 15/043; E04F 15/107; E04F 15/206; G10K 11/168; B32B 2037/1215; B32B 2307/102; B32B 2471/00

(57) ABSTRACT

In an aspect a method of manufacturing an acoustic floor panel is described. The method may include: combining a binding agent with plastic flakes; passing the plastic flakes and the binding agent to a lamination machine; applying a force to the binding agent and the plastic flakes using the lamination machine to create a plastic sheet; cutting the plastic sheet; and adding an acoustic insulator to at least a first side of the plastic sheet.

### CROSS-REFERENCE TO RELATED APPLICATIONS

The present application is a continuation of US application number 17/209,592 filed March 23, 2021. The contents of this prior application are incorporated herein by reference.

### TECHNICAL FIELD

The present application relates to acoustic insulation and, more particularly, to acoustic floor panels that may be used to reduce sound transmission in buildings.

### BACKGROUND

It is sometimes necessary or desirable to provide acoustical insulation on a floor of a building. In particular, multi-unit buildings such as condominiums and apartments may have some type of acoustic treatment to prevent sound transmission between floors. For example, such buildings may be required to satisfy defined acoustic requirements such as Impact Isolation Class (IIC) and/or Sound Transmission Class (STC) ratings.

Various techniques are sometimes used to attempt to reduce sound transmission between floors in buildings. For example, one solution involves pouring concrete over sound mats. This technique has many drawbacks including environmental concerns associated with the increased use of concrete. The use of additional concrete can also unnecessarily increase loading requirements of the building making it unsuitable for certain types of construction. Furthermore, techniques that rely on additional concrete may be costly solutions both due to the cost of material and the difficulty of installation.

Thus, there is a need for alternative acoustical insulation solutions.

### DESCRIPTION OF THE DRAWINGS

Embodiments are described in detail below, with reference to the following drawings:

FIG. 1 is a system layout diagram of a manufacturing system in accordance with an example embodiment of the present disclosure;

FIG. 2 is a flowchart of an example method of manufacturing an acoustic floor panel in accordance with an example embodiment of the present disclosure;

FIG. 3 is a cross sectional view of an example acoustic floor panel in accordance with an example embodiment of the present disclosure;

FIG. 4 is a flowchart of an example method of manufacturing an acoustic floor panel in accordance with an example embodiment of the present disclosure;

FIG. 5 is a cross sectional view of an example acoustic floor panel in accordance with an example embodiment of the present disclosure;

FIG. 6 is a flowchart of an example method of manufacturing an acoustic floor panel in accordance with an example embodiment of the present disclosure;

FIG. 7 is a cross sectional view of an example acoustic floor panel in accordance with an example embodiment of the present disclosure;

FIG. 8 is a flowchart of an example method of manufacturing an acoustic floor panel in accordance with an example embodiment of the present disclosure;

FIG. 9 is a cross sectional view of an example acoustic floor panel in accordance with an example embodiment of the present disclosure

FIG. 10 is a flowchart of an example method of manufacturing a panel in accordance with an example embodiment of the present disclosure; and

FIG. 11 is a cross sectional view of an example panel in accordance with an example embodiment of the present disclosure.

Like reference numerals are used in the drawings to denote like elements and features.

### DETAILED DESCRIPTION OF VARIOUS EMBODIMENTS

In an aspect, a method of manufacturing an acoustic floor panel is described. The method may include: combining a binding agent with plastic flakes; passing the plastic flakes and the binding agent to a lamination machine; applying a force to the binding agent and the plastic flakes using the lamination machine to create a plastic sheet; cutting the plastic sheet; and adding an acoustic insulator to at least a first side of the plastic sheet.

In another aspect, an acoustic floor panel is described. The acoustic floor panel may include a plastic layer. The plastic layer may include a plurality of plastic flakes that have been adhered together using a binding agent. The acoustic floor panel may include an acoustic insulating layer. The acoustic insulating layer may include an acoustic insulator. The acoustic insulating layer may be coupled to the plastic layer with an adhesive.

Conveniently, in this way, a floor panel may be provided which has acoustical insulation properties. The floor panel may be dimensionally stable which may allow the floor panel to be installed in a variety of applications. For example, the floor panel may be installed in a multi-unit residential building or even in single-unit residential applications to provide acoustic insulation between floors.

Further, the rigidity of at least some of the floor panels described herein may render such floor panels suitable for applications in which a supporting structure on which the floor panels are placed contain some defects. For example, the rigidity of the floor panels may allow the floor panels to be used on concrete that has some imperfections such as pitting or divots. The rigidity of the floor panel may prevent such imperfections from being felt by a person standing upon the floor panel. Further, the rigidity of the floor panel may allow the floor panel to correct for at least some unevenness in a supporting structure.

In at least some implementations, the acoustic insulator may be attached to the plastic layer using a hot melt adhesive. Conveniently, at least some such implementations may allow for end-of-life recycling of at least some of the materials used to form the acoustic floor panel. For example, one or more layer of the acoustic floor panel may be removed from one or more other layers of the acoustic floor panel to allow a layer to be recycled. For example, the acoustic floor panel may be heated in order to separate layers. By way of example, this may allow for end-of-life recycling of the acoustic insulator and/or the plastic layer.

Further, as will be described below, the acoustic floor panel may be integrated with a decorative layer, which may also be referred to as a finishing layer. The decorative layer may include, for example, any one or more of: wood veneer, carpet, vinyl and artificial grass. Other decorative layers may be used apart from those listed herein. Conveniently, the dimensional stability provided by the plastic sheet may allow the acoustic floor panel to be used as a decorative floor treatment in many types of applications including, for example, in humid or wet applications such as in basements, kitchens and bathrooms.

In at least some implementations, the acoustic floor panel may be manufactured using at least some recycled materials. At least some of the recycled materials may be materials that are otherwise not easily recyclable. For example, in at least some implementations, the acoustic floor panel may include recycled category seven (7) plastics. Such plastics may include, for example, polycarbonate plastics and/or bisphenol A (BPA), which are typically difficult to recycle.

The acoustic floor panel may also be manufactured using mixed plastics. That is, in may be unnecessary to separate plastics by type. In this way, plastics may be recycled for a new purpose in a cost-effective manner.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of …or…” is intended to cover any one or more of the listed elements, including any one of the listed elements alone, any sub-combination, or all of the elements, without necessarily excluding any additional elements, and without necessarily requiring all of the elements.

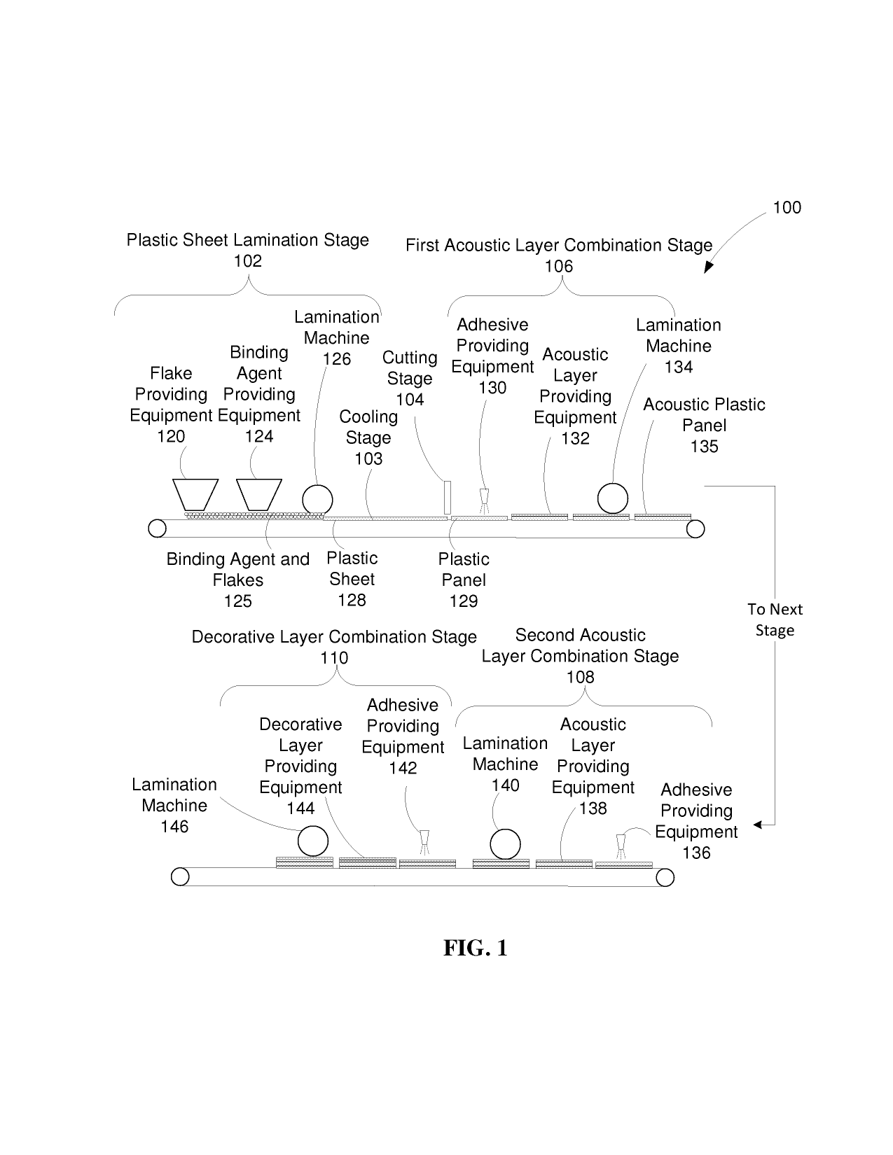

Reference will first be made to FIG. 1, which is a system layout diagram of an example manufacturing system 100. The manufacturing system 100 or a variation thereof may be used to perform a method described herein and/or to produce an acoustic floor panel of a type described herein.

The manufacturing system may include one or more stages, including, for example, any one or a combination of: a plastic sheet lamination stage 102, a first acoustic layer combination stage 106, a second acoustic layer combination stage 108, a decorative layer combination stage 110 and/or a cutting stage 104.

The plastic sheet lamination stage 102 combines a binding agent with plastic pieces, such as plastic flakes, to form a plastic sheet. The plastic flakes may be recycled plastic flakes. The plastic flakes may, in at least some implementations, include category seven (7) plastic flakes. For example, the plastic flakes may include polycarbonate plastic flakes and/or plastic flakes containing bisphenol A (BPA).

The term plastic flakes as used herein includes plastic pellets. The plastics flakes may vary in size. In at least some implementations, the plastic flakes may have an average diameter and/or particle size that is between 2 and 5 millimeters (mm).

The binding agent may be an adhesive. For example, the binding agent may be a thermally activated adhesive. The thermally activated adhesive may be an adhesive that is thermally activated at a temperature that is below a melting point of the plastic pieces. In this way, the adhesive may be cured without melting the plastic pieces.

In at least some implementations, the adhesive may be a powdered adhesive. That is, the adhesive may be a solid at room temperature and may be provided in the form of small particles.

The plastic sheet lamination stage 102 may include various equipment. By way of example, the plastic sheet lamination stage 102 may include flake providing equipment 120, binding agent providing equipment 124 and a lamination machine 126. The flake providing equipment 120 may include, for example, a hopper or a feeder of another type. The flake providing equipment 120 generally provides plastic pieces, such as plastic flakes, to other equipment in the plastic sheet lamination stage 102.

The binding agent providing equipment 124 may include, for example, a hopper or a feeder of another type. While the binding agent providing equipment 124 and the flake providing equipment 120 are depicted separately in FIG. 1, in practice they may be or include integrated or shared components. For example, a common hopper or feeder may be used to provide both the plastic flakes and the binding agent. A common hopper or feeder may aid in mixing the binding agent with the flakes.

In some implementations, to provide homogeneous mixing of the plastic flakes and the binding agent, the plastic sheet lamination stage 102 may include mixing equipment that mixes in the flakes and the binding agent together. By way of example, an agitator may be used to mix the flakes and the binding agent. Additionally or alternatively, in at least some implementations the flake providing equipment 120 and the binding agent providing equipment 124 may combine the plastic flakes and the binding agent together in a manner in which the plastic flakes and the binding agent become mixed during the addition process. For example, while FIG. 1 appears to depict the flakes as being provided before the binding agent, in practice they may be provided together. For example, the plastic flakes and the binding agent may be provided concurrently on a common workspace (such as on a conveyor). By way of example, as noted above, the plastic flakes and the binding agent may be poured or otherwise placed onto the workspace, such as the conveyor, using common equipment such as a common hopper.

The plastic sheet lamination stage 102 further includes a lamination machine 126. The lamination machine 126 may be a high-pressure lamination machine. That is, the lamination machine may be capable of exerting a high pressure on the plastic flakes and the binding agent. The plastic flakes and binding agent 125 are passed to the lamination machine 126 during processing and the lamination machine 126 applies a force to the plastic flakes and the binding agent 125 in order to create a plastic sheet 127.

The lamination machine 126 may be a heated lamination machine which heats the plastic flakes and the binding agent in order to cure the binding agent. The binding agent acts to adhere the plastic flakes to one another. Further, due to the high-pressure provided by the lamination machine, a plastic sheet 127 that is quite dense may be output from the lamination machine 126.

The lamination machine 126 may, in some implementations, be capable of exerting a compressive force of up to five hundred (500) newtons per square centimeter. However, the lamination machine may be operated at forces less than this and still produce a suitable acoustic panel. In one implementation, the lamination machine 126 may provide a compressive force that is greater than one hundred and fifty (150) newtons per square centimeter. The lamination machine 126 may provide a compressive force that is less than six hundred (600) newtons per square centimeter. In one implementation, the compressive force provided by the lamination press may be in the range of two hundred (200) newtons per square centimeter and five hundred (500) newtons per square centimeter.

The lamination machine 126 may be or include a continuous press. The lamination machine 126 may include, for example, compressive rollers or plates that exert a compressive force on the plastic flakes and binding agent 125. The lamination machine 126 may be a multi-staged lamination machine in which the plastic flakes and binding agent 125 pass through a series of compression stages. For example, multiple stages of platens and/or compressing rollers may be included.

As noted above, the lamination machine 126 may apply heat to the plastic flakes and binding agent 125 during compression. Such heat may be applied in a variety of ways. For example, in at least some implementations, heat may be transferred to the plastic flakes and binding agent 125 through a heated conveyor and/or heated platens. Other techniques may be used in other implementations.

The amount of heating will depend on the binding agent used. The heat applied to the plastic flakes and binding agent 125 may be at a temperature that is less than a melting point of the plastic flakes. In at least some implementations, the heat is between ninety (90) and one hundred and forty (140) degrees Fahrenheit. In some implementations, the heat is approximately (i.e., plus or minus 5%) one hundred (100) degrees Fahrenheit.

The lamination machine may form a plastic sheet. The plastic sheet may be between three (3) millimeters and fifty (50) millimeters thick, for example. However, the thickness may depend on the compression force that is applied.

The plastic sheet lamination stage 102 may include features or equipment in addition to the equipment illustrated in FIG. 1. For example, while not illustrated in FIG. 1, in at least some implementations, the plastic sheet lamination stage 102 may include a pre-press which is used to apply some compression to the plastic flakes and binding agent 125 before they are passed into the lamination machine 126. The amount of compression may be much less than the compression provided by the lamination machine 126 itself. The pre-press may be used to compress the plastic flakes and binding agent 125 to a desired thickness. The desired thickness may be a thickness that is compatible with the lamination machine 126. The pre-press may compress the plastic flakes and the binding agent in the absence of heat. For example, the pre-press may compress the plastic flakes and binding agent at room temperature such that the binding agent 125 is not activated through operation of the pre-press.

Additionally or alternatively, in at least some implementations, the plastic sheet lamination stage 102 may include alignment equipment. The alignment equipment may be configured to directionally align the plastic flakes. For example, the alignment equipment may be configured to align the plastic flakes such that a large portion of the plastic flakes become aligned in a common direction. That is, the plastic flakes may be aligned by grain direction. The alignment equipment may include, for example, a fluidized bed. For example, the plastic flakes may be placed in an chamber and air may be blown into the chamber. As the plastic flakes settle, they have a tendency to settle in a common direction such that the plastic flakes become directionally aligned.

The manufacturing system 100 or a portion thereof may include one more conveyors which pass workpieces and/or materials within a stage. In some implementations, the conveyors may pass workpieces and/or materials between stages. In some implementations, the manufacturing system 100 or a portion thereof may be configured for continuous processing.

As noted above, the manufacturing system 100 may include other stages. For example, the manufacturing system 100 may, additionally or alternatively, include a first acoustic layer combination stage 106, a second acoustic layer combination stage 108, a decorative layer combination stage 110, a cooling stage 103 and/or a cutting stage 104.

A plastic sheet 128 that is output from the lamination machine 126 may be cut at a cutting stage 104. The cutting stage 104 may cut or otherwise form the plastic sheet 128 into a plastic panel 129.

While a single cutting stage 104 is illustrated in FIG. 1, in practice the manufacturing system 100 may include multiple cutting stages. For example, in some implementations, a first cutting stage may cut the plastic sheet along one side and a second cutting stage may cut the plastic sheet along another side.

The cutting stage 104 may be or include a shearing machine.

In at least some implementations, the manufacturing system 100 may include a cooling stage 103. The cooling stage may be before the cutting stage 104. The cooling stage may be used to allow the plastic sheet 128 to cool down following the heating in the lamination machine 126. Such cooling may allow the plastic sheet to harden and to set in a rigid form prior to the cutting. In some implementations, the cooling stage may employ active cooling equipment such as, for example, a fan. In other implementations, the cooling stage 103 may not employ active cooling equipment and cooling may, instead, be accomplished by exposing the plastic sheet to ambient air until it is cooled down. The amount of cooling required may depend on the binding agent and/or plastic flakes used. In at least some implementations, the cooling may reduce the temperature from between 10 degrees Fahrenheit and 30 degrees Fahrenheit.

The cutting stage 104 is, in the example illustrated, situated prior to the first acoustic layer combination stage 106, the second acoustic layer combination stage 108, and the decorative layer combination stage 110. However, in other implementations, the cutting stage 104 may be situated elsewhere. For example, the cutting stage 104 may be situated after any one or more of the first acoustic layer combination stage 106, the second acoustic layer combination stage 108, and/or the decorative layer combination stage 110.

After a plastic sheet 128 has been formed, it may be passed to a first acoustic layer combination stage 106. The first acoustic layer combination stage 106 applies an acoustic insulating layer, which may also be referred to herein as an acoustic insulator, to a first side of the plastic sheet 128 (which, in the example, is the plastic panel 129). The acoustic insulator is formed of a material that reduces sound transmission. Put differently, the acoustic insulator impedes acoustic signals. The acoustic insulator may be or include rubber.

The first acoustic layer combination stage 106 may include adhesive providing equipment 130, acoustic layer providing equipment 132 and/or a lamination machine 134. The adhesive providing equipment 130 applies an adhesive to a first side of the plastic sheet 128. The adhesive may be, in at least some implementations, a hot melt adhesive. In an implementation, the adhesive may be an epoxy polyester adhesive. Such adhesives combined unique properties of thermoset and thermoplastic resins, are environmentally friendly, cost effective, and provide a good adhesion to a variety of substrates and offer a high degree of thermal resistance. In another implementation, the adhesive may be an ethyl vinyl acetate (EVA) adhesive. Such adhesives provide a wide viscosity range, and are available with flame retardant properties. In another implementation, the adhesive may be a thermo-plastic polyurethane (TPU) adhesive. Such adhesives offer oil and grease resistance, high abrasion resistance and are phthalate and plasticizer free. Another example adhesive that may be used in some implementations is co-polyamide PA which offers high chemical resistance, good adhesion to nylon and excellent adhesion and cohesion strength. Another example adhesive is co-polyester PES, which offers high adhesion and cohesion strength, is plasticizer resistant and available with flame retardant properties. Polyethylene and polypropylene adhesives may also be used in some implementations. Such adhesives are cost effective and have good adhesion properties, have a wide viscosity range and good chemical resistance to acids and alkalines and are available with flam retardant properties. Crosslinking adhesives may also be used. Such adhesives withstand high temperatures and are useful for bonding with metals, glass, fluorocarbon and silicone finishes.

An acoustic layer may then be added to the first side of the plastic sheet. In some implementations, acoustic layer providing equipment 132 may be used to add the acoustic layer to the first side of the plastic sheet. The acoustic layer providing equipment 132 may be or include various types of equipment. For example, in some implementations, the acoustic layer providing equipment 132 may be or include a roller on which the acoustic layer may be provided in roll form. In other implementations, a material handler of another type may be used.

After the acoustic layer is provided on the first side of the plastic sheet, the plastic sheet and the acoustic layer may together be provided to a lamination machine 134. The lamination machine may, in at least some implementations, be of the same or similar type as the lamination machine 126 used in the plastic sheet lamination stage 102. After the acoustic layer and the plastic sheet have been laminated together using the lamination machine, an acoustic plastic panel 135 is formed.

In some implementations, the acoustic plastic panel 135 produced following the first acoustic layer combination stage 106 may be installed in a building. That is, in some implementations, processing may be considered complete following the first acoustic layer combination stage 106. In other implementations, the acoustic plastic panel 135 may undergo further processing in order to impart the acoustic plastic panel 135 with further characteristics. For example, the manufacturing system 100 may include a second acoustic layer combination stage 108 and/or a decorative layer combination stage 110. The second acoustic layer combination stage may be configured to apply another acoustic insulator (i.e., another acoustic insulating layer) to the acoustic plastic panel 135. This second acoustic insulator may be applied at a second side of the plastic sheet 128. The second side of the plastic sheet 128 may be a side that is opposite the first side of the plastic sheet. That is, the second side of the plastic sheet may be the side of the plastic sheet that does not already have an acoustic layer. In this way, both sides of the plastic sheet may have acoustic layers. Multiple acoustic insulators may further help to reduce sound transmission through the acoustic plastic panel.

The second acoustic layer combination stage 108 may have equipment that is the same or similar to the first acoustic layer combination stage 106. In some implementations, the second acoustic layer combination stage 108 may use the same equipment provided in the first acoustic layer combination stage 106. In at least some implementations, the acoustic plastic panel 135 may be rotated or flipped prior to applying the second acoustic insulator so that the side that does not yet have an acoustic insulator provided thereon is exposed to a working side of the equipment used in the second acoustic layer combination stage 108.

The second acoustic layer combination stage 108 may include, for example, adhesive providing equipment 136, which may have the same or similar features to the adhesive providing equipment 130 of the first acoustic layer combination stage 106. The adhesive applied by the adhesive providing equipment 136 in the second acoustic layer combination stage 108 may be the same type of adhesive used in the first acoustic layer combination stage 106.

The second acoustic layer combination stage 108 may include acoustic layer providing equipment 138, which may have the same or similar features to the acoustic layer providing equipment 132 of the first acoustic layer combination stage 106. The acoustic layer applied by the acoustic layer providing equipment 138 in the second acoustic layer combination stage 108 may be the same type of acoustic layer used in the first acoustic layer combination stage 106.

The second acoustic layer combination stage 108 may include a lamination machine 140, which may have the same or similar features to the lamination machine 134 of the first acoustic layer combination stage 106. The lamination machine 140 may be operated in the same or a similar manner to the manner by which the lamination machine 134 is operated in the first acoustic layer combination stage.

In some implementations, the manufacturing system 100 may be configured to manufacture an acoustic floor panel that is integrated with a decorative layer. The decorative layer may include, for example, any one or more of: veneer (such as a wood veneer), carpet, vinyl and artificial grass. Other decorative layers may be used apart from those listed herein. In order to apply the decorative layer to the acoustic plastic panel 135, the manufacturing system 100 may include a decorative layer combination stage 110. The decorative layer combination stage 110 may include adhesive providing equipment 142, decorative layer providing equipment 144 and/or a lamination machine 146. The adhesive providing equipment may apply an adhesive to a side of the acoustic plastic panel. For example, the adhesive may be applied at a side that includes an acoustic insulator. The adhesive providing equipment 142 may be the same or similar to adhesive providing equipment 130, 136 used to apply an acoustic layer. In some implementations, the adhesive used in the decorative layer combination stage 110 may be the same or similar to the adhesive used to adhere the acoustic layer(s).

The decorative layer providing equipment 144 is a material handler. The decorative layer providing equipment 144 may take various forms and the form used may depend on the type of the decorative layer. In some implementations, the decorative layer providing equipment 144 may include a roll or roller.

The decorative layer providing equipment 144 applies the decorative layer as a layer over the adhesive added by the adhesive providing equipment 142. After the decorative layer has been layered on top of the acoustic plastic panel, it may be laminated in the lamination machine 146. The lamination machine 146 may be the same or similar to the lamination machine used to apply the acoustic layer(s).

The manufacturing system 100 of claim 1 may be modified to add or remove various stages. For example, in one implementation, the manufacturing system 100 may exclude the second acoustic layer combination stage 108 and the decorative layer combination stage 110. In this way an acoustic plastic panel 135 with an acoustic insulator at only one side may be manufactured. In another variation, the decorative layer combination stage 110 may be included but the second acoustic layer combination stage 108 may be excluded. In this way, a decorative acoustic plastic panel having an acoustic insulator at only one side may be manufactured.

Further, other stages are contemplated. For example, in one implementation, a heat reflective layer or heat dissipating layer may be laminated onto the acoustic plastic panel 135. By way of further example, in some implementations, additional cooling stages may be provided following one or more of the stages in which a lamination machine is used and in which the lamination machine is heated during use. Such additional cooling stages may allow a workpiece, such as the acoustic panel, to cool before a next stage.

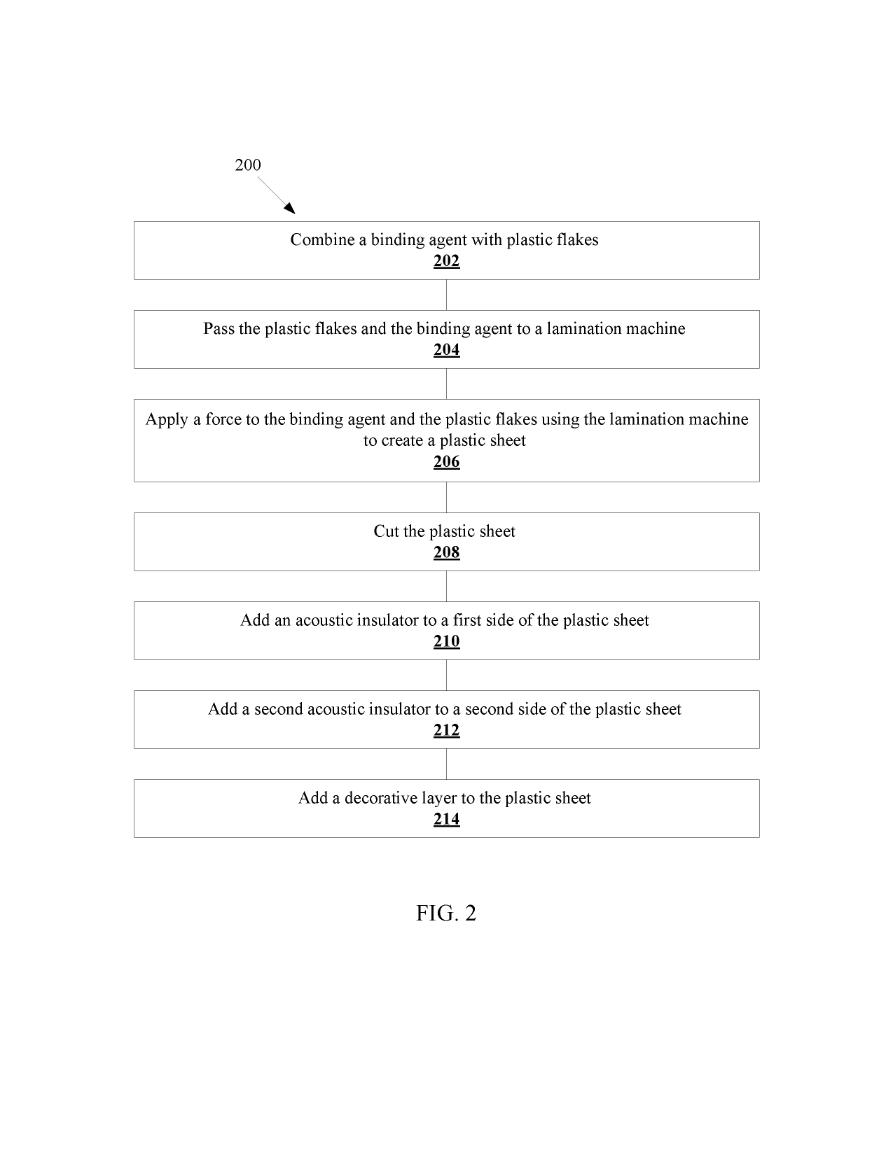

Reference will now be made to FIG. 2 which illustrates a flowchart of an example method 200 of manufacturing an acoustic floor panel. The method may be performed using a manufacturing system 100 of the type described herein or a variation thereof.

The method 200 begins at a step 202 in which a binding agent is combined with plastic flakes. The binding agent may be of the type described above with reference to FIG. 1 and the plastic flakes may be of the type described above with reference to FIG. 1. For example, the plastic flakes may include category seven (7) plastic flakes. The plastic flakes may be recycled plastic flakes. In at least some implementations, the plastic flakes may include mixed plastics. The mixed plastics may, in some implementations, be unsorted plastics. The plastic flakes may include, for example, polycarbonate plastic flakes and/or plastic flakes containing bisphenol A (BPA).

The binding agent and the flakes may be combined together using the flake providing equipment 120 and the binding agent providing equipment 124 described with reference to FIG. 1.

In some implementations, the method 200 may include a step of directionally aligning the plastic flakes. Such directional alignment may be performed using techniques described above with reference to FIG. 1. The alignment may occur prior to a step 204 of passing the plastic flakes and the binding agent to a lamination machine.

Accordingly, after the binding agent is combined with the plastic flakes, a step 204 may be performed. At step 204 the plastic flakes and the binding agent are passed to a lamination machine. Put differently, the plastic flakes and the binding agent are provided to the lamination machine. In at least some implementations, a conveyor may be used to pass the plastic flakes and the binding agent to the lamination machine.

At step 206, the lamination machine applies a force to the binding agent and the plastic flakes to create a plastic sheet. The lamination machine may be of the type described above with reference to the lamination machine 126 of the plastic sheet lamination stage.

The lamination machine may apply a force to the binding agent and, in at least some implementations, the force may be applied under heat. That is, the plastic flakes and the binding agent may be heated during the step 206. Heating may help to activate the binding agent. For example, the binding agent may be a thermally activated binding agent and the lamination machine may be configured to apply heat to the binding agent and the plastic flakes while applying the force to the binding agent and the plastic flakes to cure and/or activate the binding agent.

The method 200 may include a step 208 of cutting the plastic sheet. The cutting may be performed at the cutting stage 104 of the manufacturing system 100. For example, cutting equipment of the type described above with reference to FIG. 1 may be used to cut the plastic sheet.

The plastic sheet may be cut into panels, which may be referred to as plastic panels. The plastic sheet may be cut into a panel that is of a size and/or shape that permits easy installation in a building. For example, the plastic panels may be of a size that permits the plastic panels to be laid without gaps. By way of example, the plastic panels may be cut into squares, rectangles, triangles, hexagons, diamonds, etc.

In at least some implementations, the plastic sheet may be cut, at step 208, to include an interlocking feature. The interlocking feature may be used to couple the acoustic floor panel to another acoustic floor panel. The interlocking features may include, for example, male and female features. The male features of one plastic panel may mate with the female features of an adjacent plastic panel during installation. The interlocking features may, in at least some implementations, include snap connection features.

While not illustrated FIG. 2, in at least some implementations, the method 200 may include, prior to cutting the plastic sheet, cooling the plastic sheet. The cooling may be performed as described above with reference to the cooling stage 103 of FIG. 1. For example, the cooling may include active cooling (e.g., with a fan or other cooling device) and/or passive cooling (e.g., cooling using ambient room temperature to more gradually reduce the temperature).

The method may include, at a step 210, adding an acoustic insulator to at least a first side of the plastic sheet. For example, at step 210 an acoustic insulator may be added to a first side of the plastic sheet. Step 210 may be performed using the manufacturing system 100. For example, the first acoustic layer combination stage 106 may be used to add the acoustic insulator to the first side of the plastic sheet. Step 210 may be performed as described above with reference to the first acoustic layer combination stage 106 of the manufacturing system 100. For example, the acoustic insulator may include rubber.

In at least some implementations, the acoustic insulator may be attached to the plastic sheet at step 210 using a hot melt adhesive. The hot melt adhesive may, in at least some implementations, be cured in a lamination machine.

In some implementations, at a step 212, the method may include adding a second acoustic insulator to a second side of the plastic sheet. The second side is a side that is opposite the first side. That is, the second side of the plastic sheet is the side on which an acoustic insulator has not yet been attached during step 210. The acoustic insulator used at step 212 may be of the same type used at step 210.

Step 212 may be performed in the same or a similar way to step 210. In at least some implementations, step 212 may be performed using the manufacturing system 100 of FIG. 1. For example, the second acoustic layer combination stage 108 may be used to perform the step 212. Step 212 may, therefore, include features generally described above with reference to the second acoustic layer combination stage 108.

At a step 214, the method 200 includes adding a decorative layer to the plastic sheet. The decorative layer may be of a variety of types. For example, the decorative layer may include any of: veneer (such as wood veneer), carpet, vinyl, and artificial grass. Other decorative layers may be used.

The decorative layer may be added to the plastic sheet using the manufacturing system 100 of FIG. 1. For example, the decorative layer may be added at the decorative layer combination stage 110. The decorative layer may be added on the acoustic insulator. In at least some implementations, a lamination machine may be used to laminate the decorative layer to the acoustic insulator. In at least some implementations, the decorative layer may be added to the plastic sheet using a hot melt adhesive. The hot melt adhesive may be added to the acoustic insulator such that it is between the decorative layer and the acoustic insulator. The adhesive may then be cured; for example, through heating provided by the lamination machine.

It may be noted that the order of at least some steps in the method 200 may be altered and that the method may include other steps that are not depicted or omit some of the steps that are depicted.

By way of example, in at least some implementations, the step 208 of cutting the plastic sheet may be performed at another portion of the method 200. By way of example, the plastic sheet may be cut after the acoustic insulator is added to the first side of the plastic sheet (i.e., after 210). By way of further example, the plastic sheet may be cut after the acoustic insulator is added to the second side of the plastic sheet (i.e., after 212). By way of further example, the plastic sheet may be cut after a decorative layer is added to the plastic sheet.

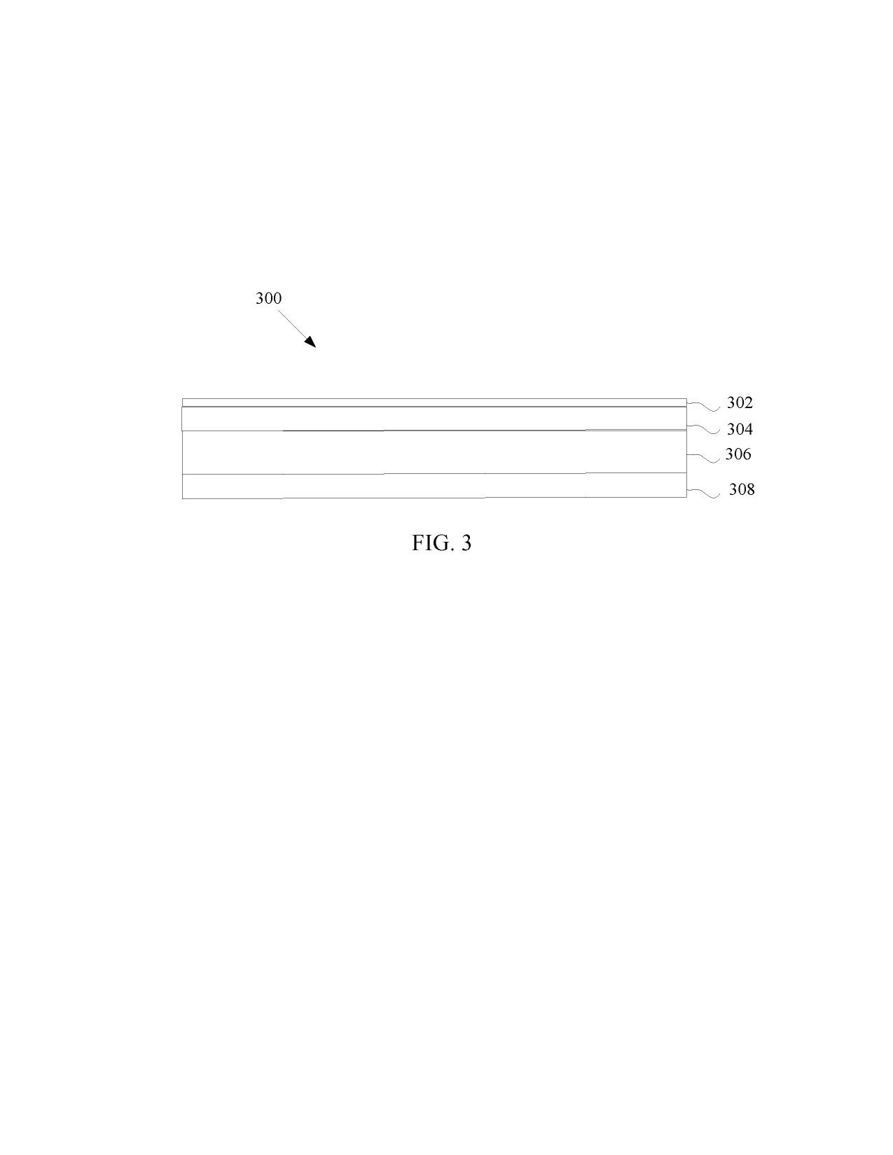

Reference will now be made to FIG. 3 which illustrates a cross sectional view of an example acoustic panel 300 in accordance with an example implementation of the present disclosure. The acoustic panel 300 may also be referred to herein as an acoustic floor panel. The example acoustic panel 300 of FIG. 3 is a decorative acoustic floor panel that integrates a decorative floor covering with a floor panel having soundproofing properties. The acoustic panel 300 may be manufactured using the manufacturing system 100 of FIG. 1 and/or the method 200 of FIG. 2.

The example acoustic panel 300 is a decorative acoustic panel which includes a decorative layer 302. The decorative layer 302 may be of a type described above. For example, the decorative layer may be one or more of: veneer (such as a wood veneer), carpet, vinyl; and artificial grass.

The decorative layer 302 may be coupled to another layer of the acoustic panel 300. For example, the decorative layer 302 may be coupled at an exterior of the acoustic floor panel such that the decorative layer 302 forms the outside of the acoustic floor panel 300.

The acoustic floor panel 300 includes an acoustic insulating layer constructed of an acoustic insulator. The acoustic insulating layer may be an acoustic insulator of the type described above. For example, the acoustic insulating layer may be or include rubber. In the example of FIG. 3, the acoustic panel 300 includes two acoustic insulating layers. A first acoustic insulating layer 304 may be provided at a first side of a plastic layer 306 and, in the illustrated example, a second acoustic insulating layer 308 is provided at a second side of the plastic layer 306. The plastic layer 306 may be a plastic sheet of the type described herein. For example, the plastic layer may be formed using the manufacturing system 100 of FIG. 1 and, in particular, using the plastic sheet lamination stage 102. The plastic layer 306 includes a plurality of plastic flakes that have been adhered together using a binding agent. The plastic flakes may be as described above. For example, the plastic flakes may be recycled plastic flakes. The plastic flakes may include category seven (7) plastics including, for example, polycarbonate plastic flakes and plastic flakes containing bisphenol A (BPA). A single acoustic floor panel 300 may include various plastics. That is, more than one type of panel may be present in a single panel.

In at least some implementations, the plastic flakes in the plastic layer 306 may be directionally aligned within the plastic layer.

Various layers of the acoustic floor panel 300 may be attached to one another using an adhesive (not illustrated). For example, an adhesive may be used to couple the decorative layer 302 to the first acoustic insulating layer 304, an adhesive may be used to couple the first acoustic insulating layer 304 to the plastic layer 306, and/or an adhesive may be used to couple the plastic layer 306 to the second acoustic insulating layer 308. The adhesive used for coupling the various layers may be the same adhesive or it may be a different adhesive. In at least some implementations, the adhesives may be or include a hot melt adhesive.

While not illustrated in FIG. 3, in at least some implementations, the acoustic plastic panel may include an interlocking feature to couple the acoustic floor panel to another acoustic floor panel.

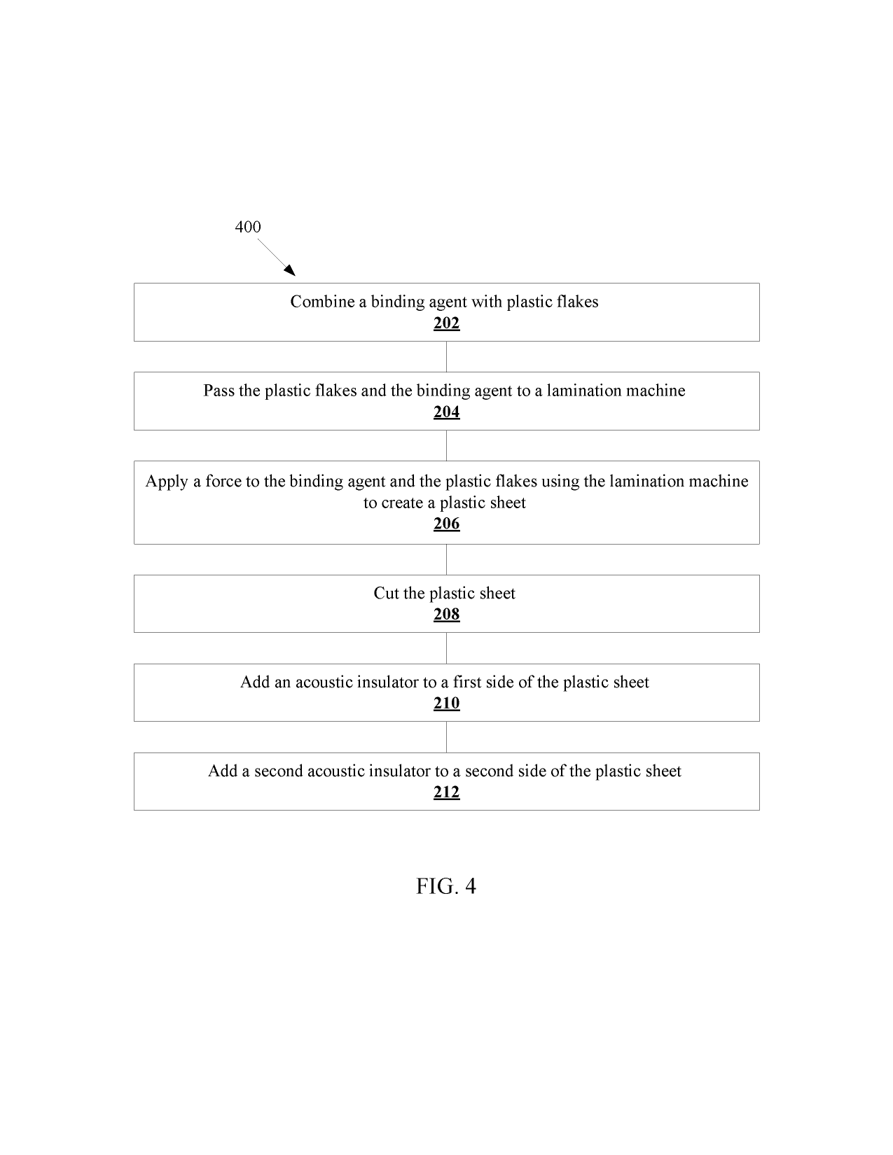

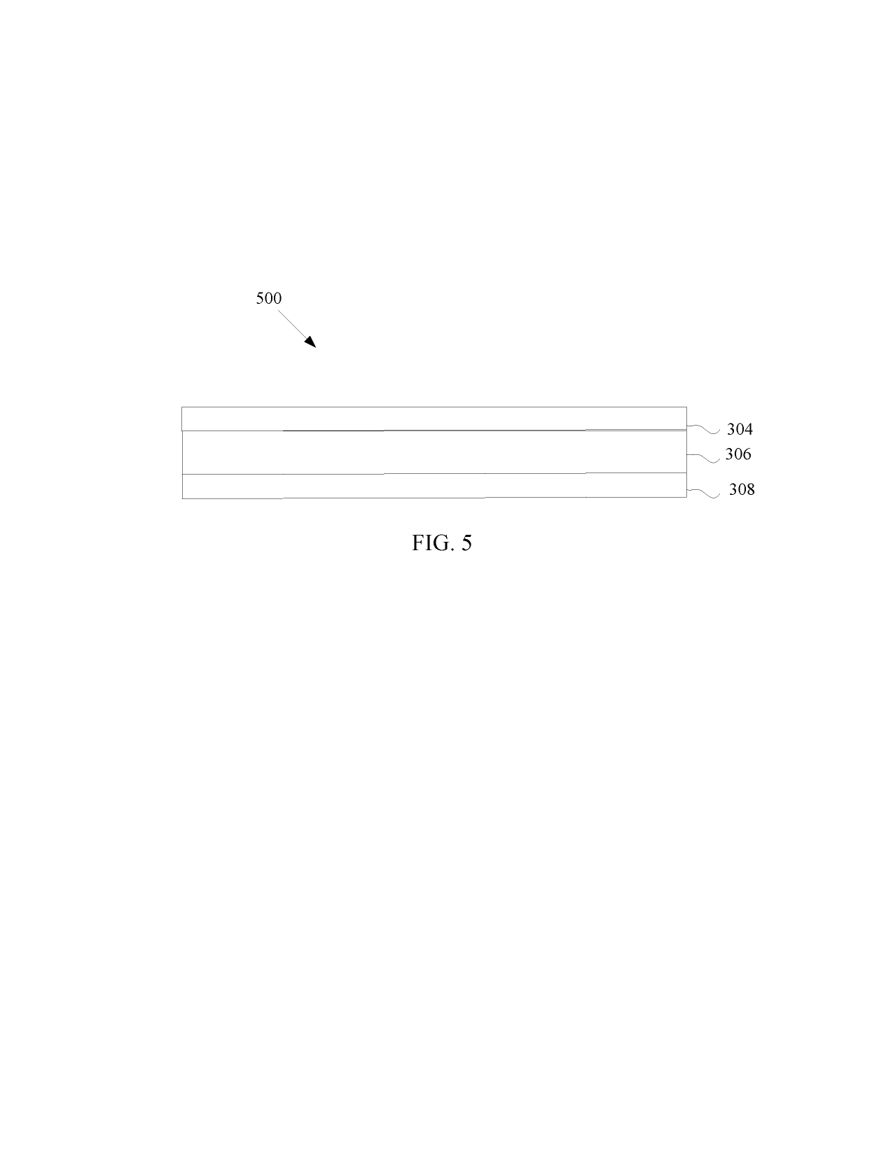

The method 200 of FIG. 2 may be modified in order to manufacture acoustic panels having various properties. For example, as illustrated in FIG. 4, in some implementations, the decorative layer may be omitted. That is, a method 400 illustrated in FIG. 4 may include the steps of the method 200 of FIG. 2 except for the step 214 of adding a decorative layer to the plastic sheet. In this way, an acoustic floor panel 500, an example of which is illustrated in FIG. 5, may be manufactured to include the first acoustic insulating layer 304, the plastic layer 306 and the second acoustic insulating layer 308 but may exclude the decorative layer 302 of FIG. 3. A panel manufactured in this way may be used as an underlayment that may be placed below a finished floor material that may be installed on site.

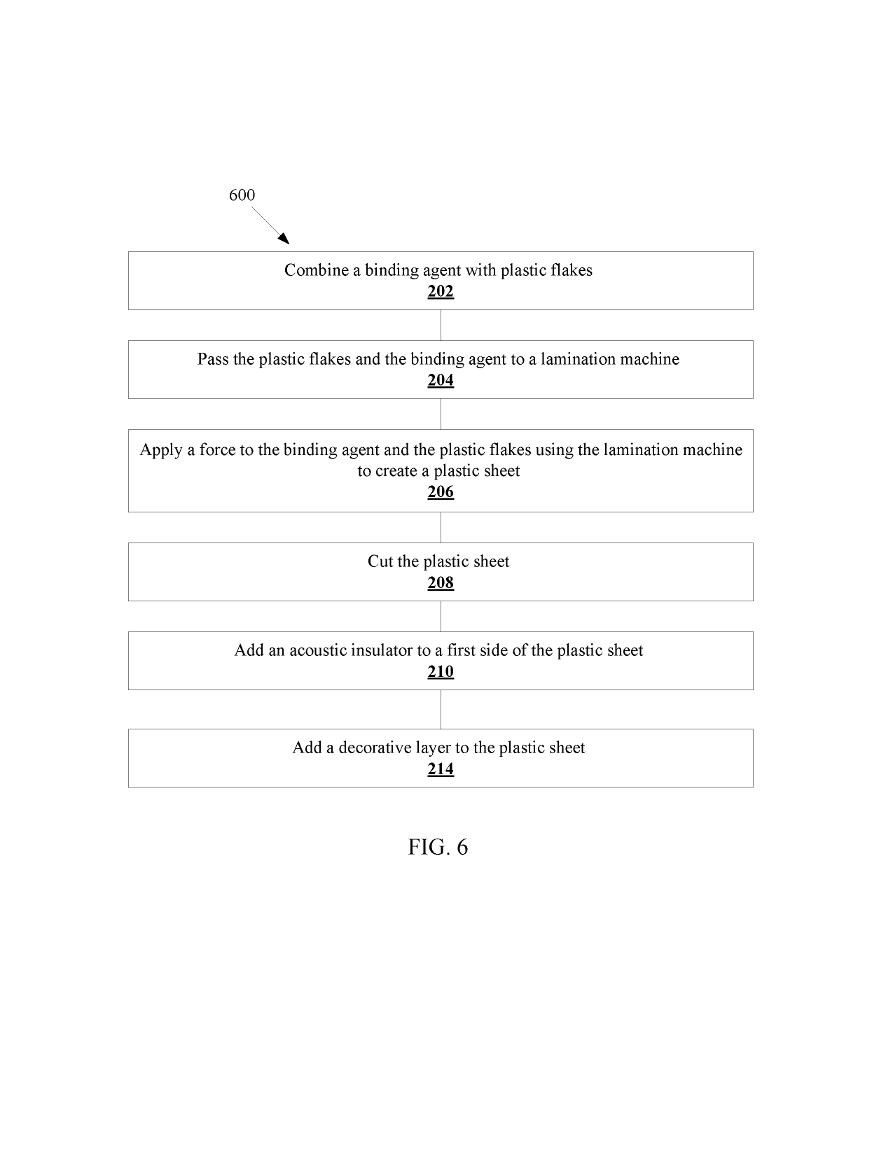

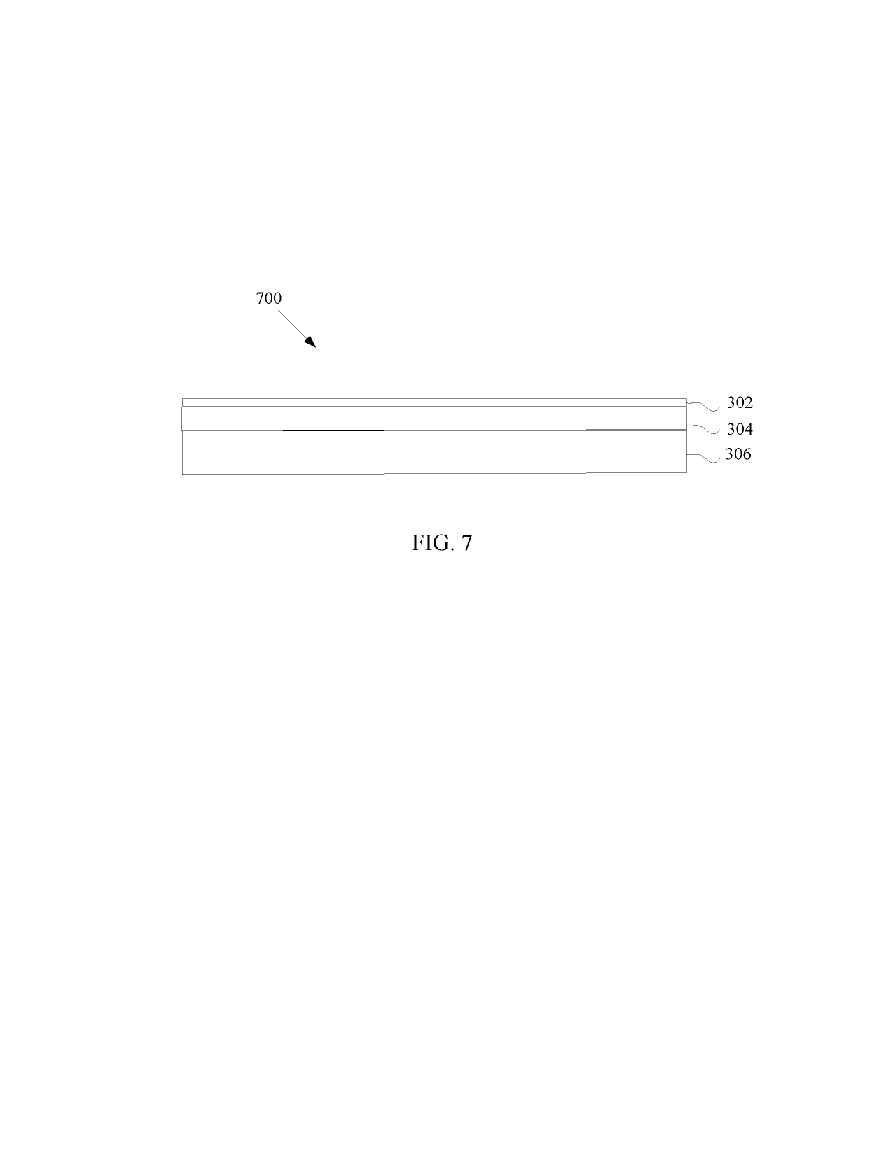

In another variation, illustrated in FIG. 6, the method 200 of FIG. 2 may be modified to exclude step 212 so that only one acoustic insulating layer is added. That is, a method 600 illustrated in FIG. 6 may include the steps of the method 200 of FIG. 2 except for the step 212 of adding a second acoustic insulator to the second side of the plastic sheet. In this way, an acoustic floor panel 700, an example of which is illustrated in FIG. 7, may be manufactured to include the first acoustic insulating layer 304, the plastic layer 306, and the decorative layer, but to exclude the second acoustic insulating layer 308 of FIG. 3. A panel manufactured in this way may provide some sound attenuation. In the illustrated example, the decorative layer 302 is applied to the first acoustic insulating layer 304 but in other implementations, the decorative layer 302 and the first acoustic insulating layer 304 may be at opposite sides of the plastic layer 306.

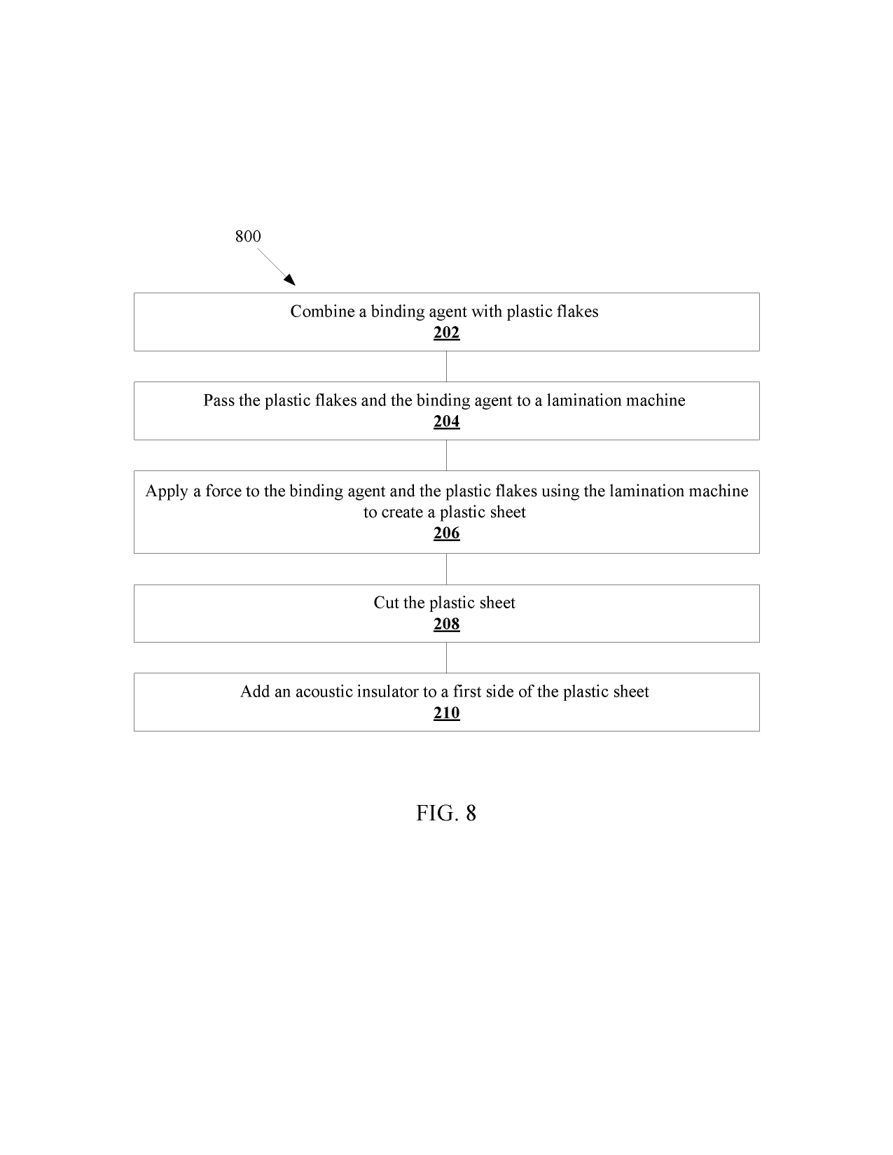

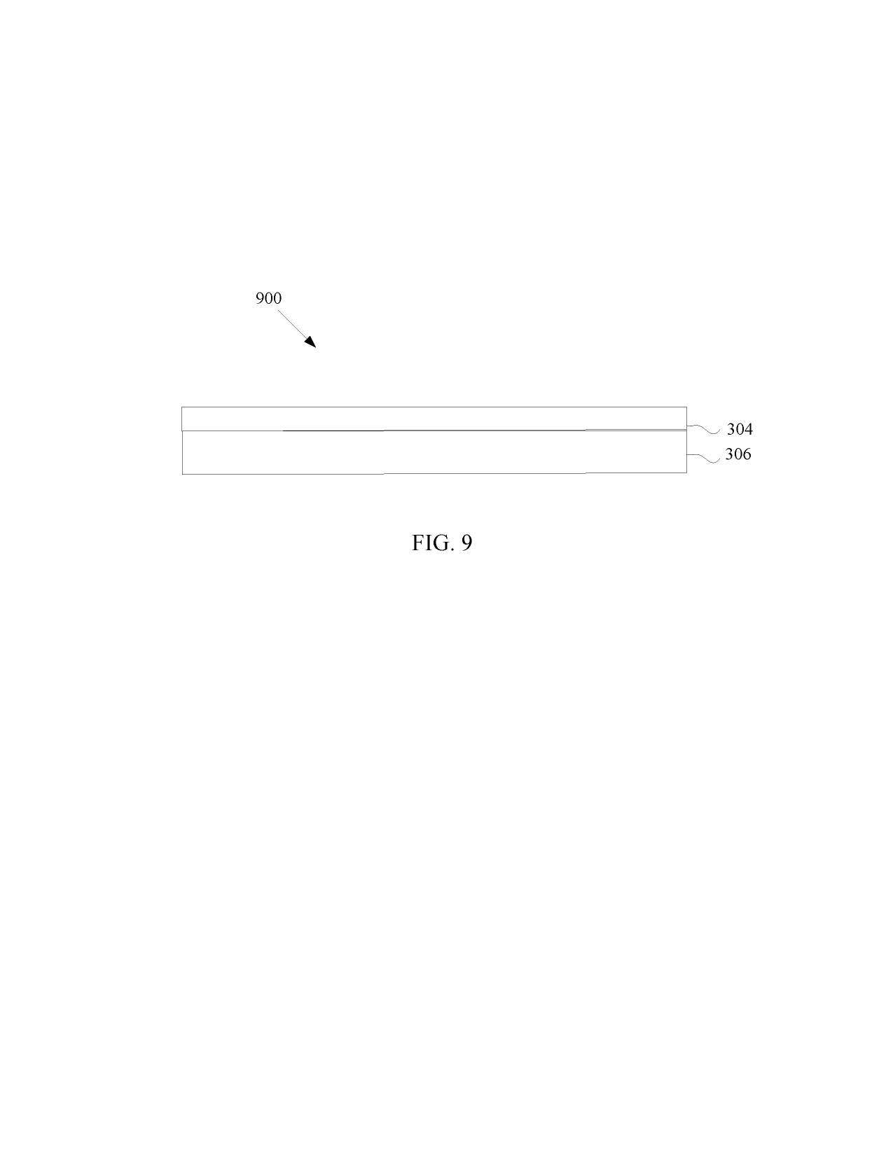

In another variation, illustrated in FIG. 8, the method 200 of FIG. 2 may be modified to exclude steps 212 and 214 so that only one acoustic insulating layer is added. That is, a method 800 illustrated in FIG. 8 may include the steps of the method 200 of FIG. 2 except for the step 212 of adding a second acoustic insulator to the second side of the plastic sheet and the step 214 of adding the decorative layer. In this way, an acoustic floor panel 900, an example of which is illustrated in FIG. 9, may be manufactured to include the first acoustic insulating layer 304 and the plastic layer 306, but to exclude the decorative layer 302 and the second acoustic insulating layer 308 of FIG. 3. A panel manufactured in this way may provide some sound attenuation. A panel manufactured in this way may be used as an underlayment that may be placed below a finished floor material that may installed on site.

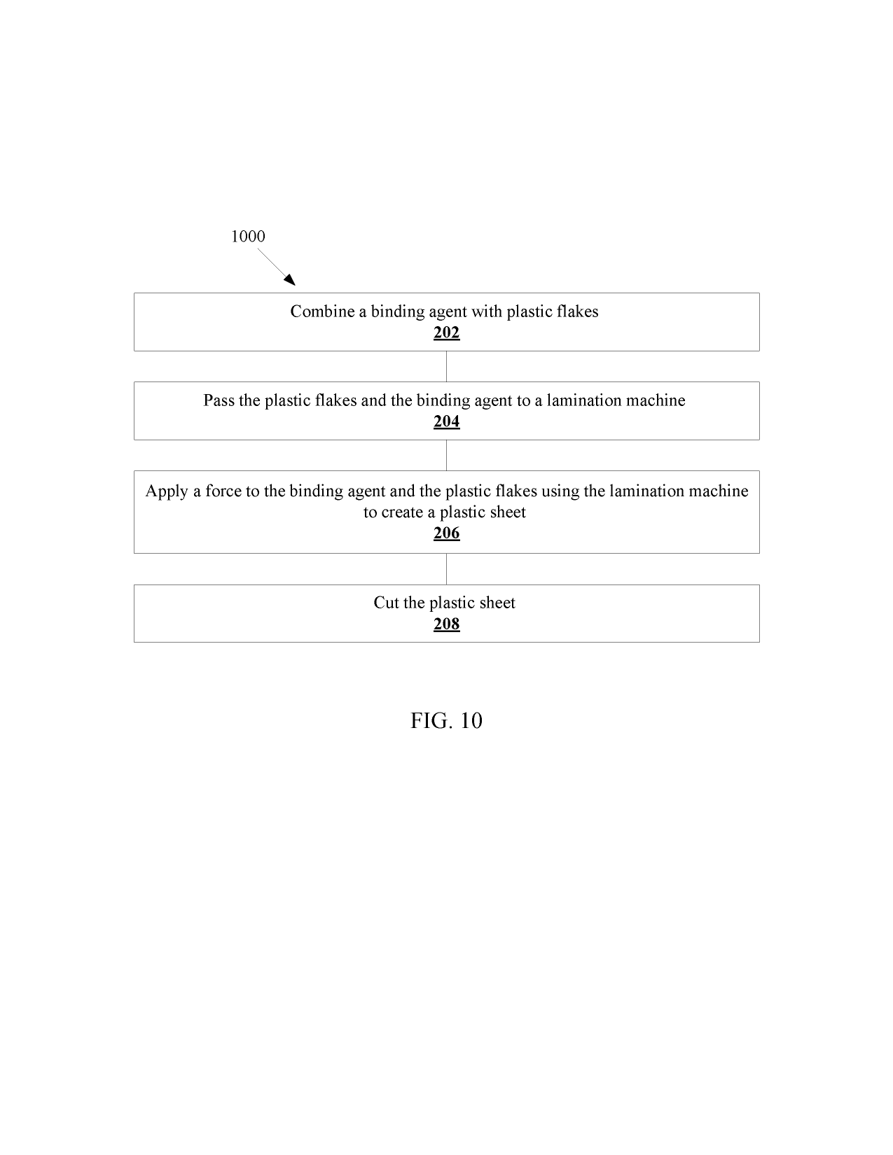

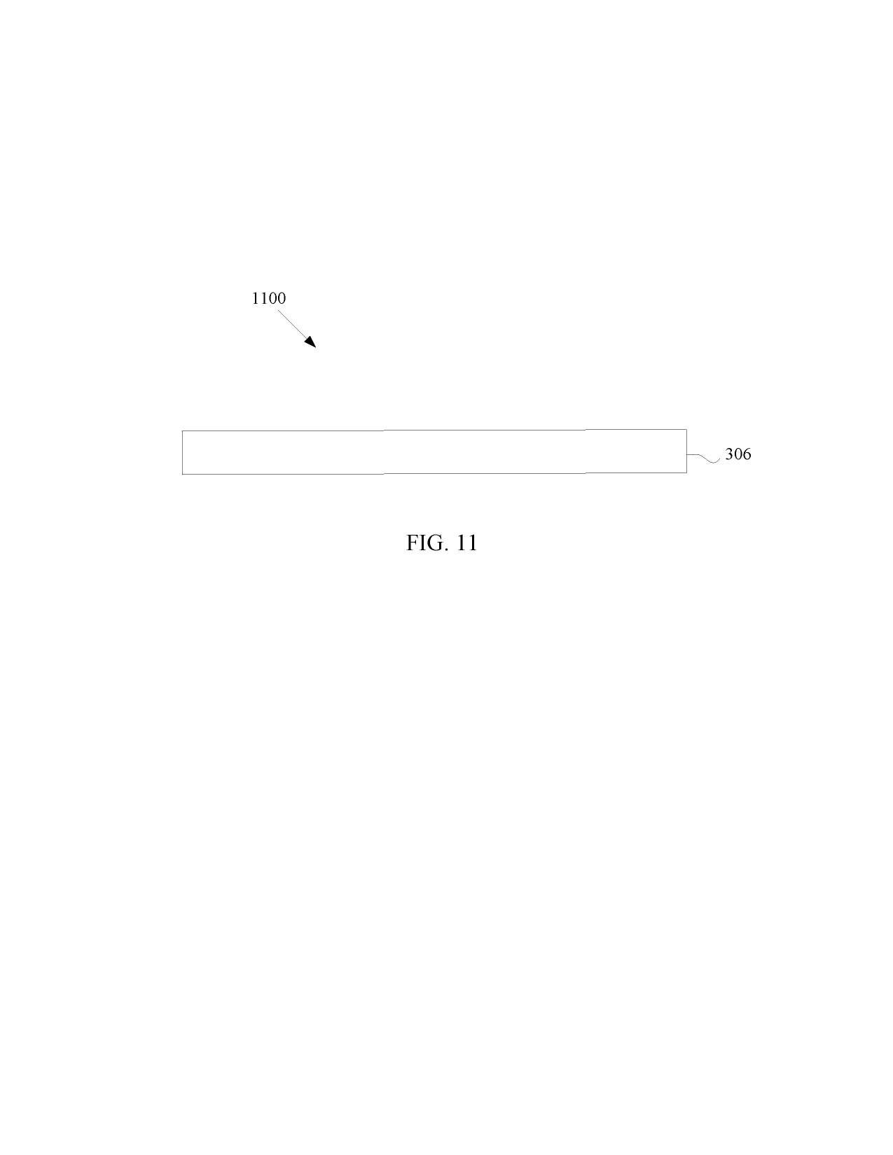

In another variation, illustrated in FIG. 10, the method 200 of FIG. 2 may be modified to exclude steps 210, 212 and 214 so that a plastic panel (or plastic sheet) having no acoustic insulating layer may be produced. That is, a method 1000 illustrated in FIG. 10 may include the steps of the method 200 of FIG. 2 except for the step 210 of adding a first acoustic layer, the step 212 of adding a second acoustic insulator to the second side of the plastic sheet and the step 214 of adding the decorative layer. In this way, an acoustic floor panel 1100, an example of which is illustrated in FIG. 11, may be manufactured to include the plastic layer 306, but to exclude the first acoustic insulating layer 304, decorative layer 302 and the second acoustic insulating layer 308 of FIG. 3. Such a panel may be used for any one of a number of purposes including, for example, as a building material that may be used in place of lumber or, in some cases concrete.

In some instances, the method 1100 may be modified to include the step 214 of adding the decorative layer. The decorative layer may be applied directly to the plastic panel or plastic sheet. In this way, a decorative floor panel may be provided that uses the plastic panel as a substrate for a decorative layer. It will be appreciated that such a floor covering may offer a number of benefits over traditional floor products, such as engineered or hardwood flooring. For example, the floor product may divert waste from landfills and may offer a number of beneficial properties, such as a dimensional stability, rigidity, etc.

In some instances, any of the panels described herein may be cut or formed into planks. The panels or planks may, in some instances, include locking features which are designed to allow the panels or planks to interlock with adjacent panels or planks.

As noted, certain adaptations and modifications of the described embodiments can be made. Therefore, the above discussed embodiments are considered to be illustrative and not restrictive.

1. A method of manufacturing an acoustic floor panel, the method comprising:
combining a thermally activated adhesive with a plurality of recycled plastic flakes, the recycled plastic flakes including category seven (7) plastic flakes comprising at least one of polycarbonate plastic flakes and plastic flakes containing bisphenol A (BPA);
applying heat to activate the thermally activated adhesive at a temperature below a melting point of the recycled plastic flakes;
applying pressure while the thermally activated adhesive is activated to bond the recycled plastic flakes together without melting the recycled plastic flakes, thereby forming a consolidated plastic substrate in which the recycled plastic flakes remain unmelted and retain discrete flake morphology; and
coupling an acoustic insulating layer to at least one side of the consolidated plastic substrate.

2. The method of claim 1, wherein the thermally activated adhesive is a powdered adhesive that is solid at room temperature.

3. The method of claim 1, wherein the thermally activated adhesive is activated at a temperature between 90°F and 140°F.

4. The method of claim 3, wherein the thermally activated adhesive is activated at approximately 100°F ±5%.

5. The method of claim 1, wherein activating the thermally activated adhesive comprises curing the adhesive without melting the recycled plastic flakes.

6. The method of claim 1, wherein applying pressure comprises applying a compressive force greater than 150 newtons per square centimetre.

7. The method of claim 6, wherein the compressive force is between 200 and 500 newtons per square centimetre.

8. The method of claim 1, wherein applying pressure and heat forms the consolidated plastic substrate having a thickness between 3 millimetres and 50 millimetres.

9. The method of claim 1, further comprising cooling the consolidated plastic substrate after bonding and before coupling the acoustic insulating layer.

10. The method of claim 1, wherein the recycled plastic flakes comprise unsorted mixed recycled plastics.

11. The method of claim 1, wherein the recycled plastic flakes have an average particle size between 2 millimetres and 5 millimetres.

12. The method of claim 1, further comprising directionally aligning the recycled plastic flakes prior to applying the heat.

13. The method of claim 1, wherein bonding the recycled plastic flakes together forms a substantially homogeneous mixture of recycled plastic flakes and thermally activated adhesive.

14. The method of claim 1, wherein coupling the acoustic insulating layer comprises attaching the acoustic insulating layer using an adhesive selected from epoxy polyester, ethyl vinyl acetate (EVA), thermoplastic polyurethane (TPU), co-polyamide (PA), co-polyester (PES), polyethylene, and polypropylene adhesives.

15. The method of claim 1, further comprising coupling a decorative layer exterior to the acoustic insulating layer.

16. The method of claim 15, wherein the decorative layer comprises at least one of wood veneer, carpet, vinyl, and artificial grass.

17. The method of claim 1, wherein the consolidated plastic substrate is formed to be sufficiently rigid to reduce perceptibility of surface imperfections in an underlying concrete surface.

18. The method of claim 1, further comprising heating the acoustic floor panel after use to separate the acoustic insulating layer from the consolidated plastic substrate for recycling.

19. The method of claim 1, wherein coupling the acoustic insulating layer comprises laminating the acoustic insulating layer to the consolidated plastic substrate using a lamination machine.

20. An acoustic floor panel comprising:
a consolidated plastic substrate comprising a plurality of recycled plastic flakes bonded together by a thermally activated adhesive, the recycled plastic flakes including category seven (7) plastic flakes comprising at least one of polycarbonate plastic flakes and plastic flakes containing bisphenol A (BPA),
wherein the thermally activated adhesive bonds the recycled plastic flakes together without melting the recycled plastic flakes such that the recycled plastic flakes remain unmelted and retain discrete flake morphology within the consolidated plastic substrate; and
an acoustic insulating layer coupled to at least one side of the consolidated plastic substrate.
